(19) United States
(12) Patent Application Publication
(10) Pub. No.: US 2007/0296626 A1
(43) Pub. Date: Dec. 27, 2007

(54) Microwave Transceiver Unit for Detecting the Level of Waste in a Furnace

(75) Inventors: Valeri G. Gnedenko, Moscow (RU); Igor V. Goryachev, Moscow (RU); Sergei A. Dmitriev, Moscow (RU); David Pegaz, Netanya (IL)

Correspondence Address: BROWDY AND NEIMARK, P.L.L.C.;624 NINTH STREET, NW, SUITE 300, WASHINGTON, DC, 20001-5303, US

(73) Assignee: E.E.R. Environmental Energy Resources Ltd., Ramat-Gan (IL)

(21) Appl. No.: 10/584,911

(22) PCT Filed: Dec. 6, 2004
(86) PCT No.: PCT/IL04/01106

§ 371 Date: Jun. 11, 2007

(30) Foreign Application Priority Data
Dec. 29, 2003 (IL) 159634

(51) Int. Cl. G01F 23/284

(52) U.S. Cl. 342/124; 110/349; 324/644

(57) ABSTRACT

A microwave transceiver unit is for use in a shaft furnace is described. Two or more of the transceiver units are installed in the furnace and are used to determine the level of the waste in the shaft. Methods of using the transceiver units to determine the level of waste in the shaft of the furnace are also described.

### TECHNICAL FIELD

The present invention relates to a plant or apparatus for the conversion of waste, including the processing, treatment or disposal of waste. In particular, the present invention is directed to an improved arrangement for detecting and monitoring the level of waste in such a plant or apparatus.

### BACKGROUND

The processing of waste including municipal waste, medical waste, toxic and radioactive waste by means of plasma-torch based waste processing plants is well known.

One problem commonly encountered in such plants is the detection of the level of waste within the shaft furnace or processing chamber of the plant, since detectors for this purpose need to work in a high temperature environment, which can also be corrosive. Furthermore, in many cases, the detectors are inaccessible from outside of the furnace.

In some types of plants, the processing chamber has an upper waste inlet with a feeding conduit extending into the chamber. There are certain advantages to maintaining a “plug” of waste in the lower part of this conduit, such that the column of waste extends from inside of this conduit to the lower part of the chamber, where gasification and pyrolysis of the waste are in progress. In particular, the waste column flares typically outwardly from the bottom edge of the conduit towards the inner walls of the processing chamber. This provides a substantially peripheral space between the upper part of the chamber and the conduit outer wall, and a product gas outlet is provided in the chamber in communication with this space. The plug of waste within the conduit provides a barrier to the product gases formed in the gasification process, substantially minimizing any outflow of the gases via the waste inlet. This minimizes any potential fire or explosion hazard that may occur if the gases are released into the atmosphere via the waste inlet, which may be possible even if this comprises an air lock system. Instead, due to the presence of this plug, the product gases are channeled out of the chamber, substantially exclusively, via the outlet port.

Accordingly, it is particularly important in such cases to monitor the height of the waste within the feed conduit itself. However, the aforementioned problems associated with level detectors are even greater in reactors comprising such conduits. For example, the conduit itself is less accessible than the outside of the reactor, which is the usual location for prior art height indicators, since the conduit is fully located within the shaft furnace or processing chamber. Thus, any regular detector that is connected to the conduit would be difficult to maintain and replace, typically requiring dismantling of the upper part of the chamber and/or the feeding mechanism. Furthermore, the thermal expansion of the feed tube with respect to the ceramic lining of the chamber also presents a problem in that the electrical connection between such detectors mounted to the conduit and the outside of the chamber needs to be expandable. On the other hand, prior art detectors that are mounted on the outside of the processing chamber would not be able to detect the level of waste within the conduit itself.

A microwave transmitter receiver arrangement for detecting the level of waste is generally known from JP 10307053 and JP 20310554. Other prior art publications, such as U.S. Pat. No. 3,456,715, U.S. Pat. No. 6,310,574, U.S. Pat. No. 5,703,289, U.S. Pat. No. 5,507,181, U.S. Pat. No. 4,566,321, and JP 57029913 relate to various level monitoring systems which are boltable to a casing which contains the material whose level is to be monitored. U.S. Pat. No. 3,456,715 relates to an ultrasonic-based system for detecting the level of melt in a solidification water cooled collar. Ultrasonic based systems, however, are generally unsuitable for height detection in such processing chambers because of the influence of the ultrasonic background signals generated by the processes inside the chamber.

None of these documents is directed to providing a solution to the problem of monitoring the height of waste in a high temperature environment within a feed conduit located inside a shaft furnace or processing chamber. Further, none addresses the problems of accessibility and maintenance of the detectors that may be located in the peripheral space, or of the thermal expansion of the feed tube.

It is therefore an aim of the present invention to provide a height detection apparatus and system for monitoring the level of waste in a plasma waste converting plant, particularly the feed conduit thereof, which overcomes the limitations of prior art detection apparatuses and systems.

It is another aim of the present invention to provide such an apparatus and system that may be incorporated into a municipal solid waste processing apparatus.

It is another aim of the present invention to provide such an apparatus and system that is relatively simple mechanically and thus economic to incorporate into a processing plant design.

It is another aim of the present invention to provide such an apparatus and system incorporated as an integral part of a plasma-torch based type waste converter.

It is also an aim of the present invention to provide such an apparatus and system that is readily retrofittable with respect to at least some existing plasma-torch based waste converters.

It is another aim of the present invention to provide such an apparatus and system the operation of which is substantially unaffected by the thermal expansion of the feed conduit with respect to the chamber.

It is another aim of the present invention to provide such an apparatus and system which may be accessed, maintained or replaced in a relatively easy manner without the need for dismantling the feed mechanism or the chamber itself.

Other purposes and advantages of the present invention will appear as the description proceeds.

### SUMMARY OF INVENTION

The present invention relates to a microwave transceiver unit for use in a shaft furnace having an external wall and an inner wall spaced therefrom, said microwave transceiver unit comprising:

first screen means transparent to microwave radiation, mountable to a suitable portal provided in said inner wall;

an elongate body having a configuration adapted for reversibly mounting to said external wall through an aperture provided in said external wall, said body having an axial dimension such that a first end of said body extends into said furnace from said aperture at least into proximity with said first screen, such as to permit relative movement between said body and said first screen means;

said body comprising microwave transmission/receiving means associated with said first end and operatively connectable to any one of a microwave generating means and microwave detection means;

wherein during operation of said microwave transceiver unit at least a portion of said screen is in aligned relationship with said microwave transmission/receiving means and wherein said screen is sufficiently large to maintain an aligned relationship between at least a portion of said first screen with respect to said microwave transmission/receiving means for a range of displacements of said first screen with respect to said microwave transmission/receiving means.

Such a body may comprise:

a metallic wave conductor coupled at a first end thereof to said transmission/receiving means, the second end of said conductor being operatively connectable to any one of a microwave generation means and a microwave detection means;

an insulation layer substantially surrounding at least said conductor;

an outer metallic layer substantially surrounding said insulation layer.

The screen means and second screen means may be made from any suitable dielectric material; the insulation layer may be substantially tubular; The outer metallic layer may be made from steel. The body may have a substantially cylindrical external profile.

The microwave transceiver unit may further comprise a sleeve member having:

an external configuration adapted for sealingly mounting said sleeve in said aperture in said wall of said furnace; and

an internal configuration adapted for reversibly accommodating said body sealingly with respect thereto.

The sleeve member and said body may each comprise suitable flanges which are mutually facing when said sleeve member and said body mounted together. A suitable sealing gasket may be provided, adapted for accommodation between said mutually facing flanges for sealing sleeve member with respect to said body.

The range of displacements may be correlated to the thermal expansion of said inner wall with respect to said outer wall. The body may be distanced from said first screen means sufficiently to permit displacement of said first screen means with respect to said microwave transmission/receiving means. The body may comprise displacement means in abutting contact with one of said inner wall and said first screen means to permit displacement of said first screen means with respect to said microwave transmission/receiving means. The displacement means may comprise at least one wheel mounted for rotation with respect to said body, wherein said wheel is in rotatable contact with at least one of said inner wall and said first screen means. At least one suitable rail may be provided on at least one of said inner wall and said first screen means corresponding to said at least one wheel, wherein during operation of said transceiver unit, said at least one wheel is in rotatable contact with a corresponding said rail.

The present invention is also directed to an apparatus for monitoring waste in a waste converting apparatus, said waste converting apparatus comprising a waste processing chamber having a waste inlet port at an upper longitudinal end thereof and an external peripheral wall, and further comprising a waste conduit in the form of an internal wall extending peripherally or partially from said inlet into said chamber to a predetermined depth such as to form a peripheral or other space between an outside of said conduit and an inside of said external wall, said apparatus comprising at least one pair of microwave transceiver units, comprising at least one said microwave transceiver according to the invention, and possibly a regular microwave transceiver, depending on the configuration of the inner wall, wherein for each said pair:

the said microwave transceiver units are arranged in opposed horizontal relationship with respect to said upper longitudinal end;

said body of each said microwave transceiver unit is sealingly accommodated in a said aperture formed in said outer peripheral wall;

said conduit comprises a pair of portals comprising a said first screen means, said portals being located on said conduit at positions such that each said first screen means is aligned with a corresponding one of said microwave transceiver units of said pair; and

one said transceiver unit is operatively connectable to a suitable microwave generating means. The other said transceiver unit is operatively connectable to a suitable microwave detection means.

Preferably, the apparatus comprises more than one pair of said microwave transceiver units, wherein each said pair is located at a different height along said depth of said conduit, and preferably each said pair is located at a different angular disposition with respect to a longitudinal axis of said conduit. Adjacent said pairs may be arranged in orthogonal relationship with respect to a longitudinal axis of said conduit.

The present invention is also directed to a system for monitoring waste in a waste converting apparatus comprising at least one said apparatus, wherein for each said pair of transceiver units, one said transceiver unit is operatively connected to a suitable microwave generation means, and wherein the other transceiver unit of said pair is operatively connected to a suitable microwave detection unit. The system preferably further comprises suitable control means operatively connected to said microwave generation means and to said microwave detection unit.

The present invention also relates to a method for monitoring the level of waste in a shaft furnace having an external wall and an inner wall spaced therefrom, comprising providing at least at one location on said shaft furnace:

an aperture in said outer wall;

an aperture in said inner wall and covering the same with suitable screen means

a first suitable microwave transmission/receiving means through said aperture into proximity with said screen means, such that a part of said transmission/receiver means is in sealing contact with said outer wall; and

providing a second microwave transmission/receiving means substantially diametrically opposed to said first transmission/receiving means;

transmitting suitable microwave radiation via one of first or second microwave transmission/receiving means and receiving a received radiation with the other one of said first or second microwave transmission/receiving means;

comparing the intensity of the received radiation with the transmitted radiation to determine the level of waste in said shaft furnace.

According to the method, when the intensity of said received radiation is below a predetermined threshold value it may be determined that the level of waste is substantially below the level of said first microwave transmission/receiving means. Conversely, when the intensity of said received radiation is at or above a predetermined threshold value it is determined that the level of waste is substantially at or above the level of said first microwave transmission/receiving means.

According to the method a second pair of said microwave transmission/receiving means may be provided at a location longitudinally displaced from the said first and second microwave transmission/receiving means, and wherein a waste flow rate in said furnace is determined by determining the time interval between the point at which it is determined that one of said pairs of microwave transmission/receiving means is no longer detecting waste and the point at which the next pair of said microwave transmission/receiving means is no longer detecting waste thereat. The threshold value may be controlled as desired, and may be further adjusted according to the general composition of the waste being introduced into said furnace.

Thus, according to the invention, the apparatus/system comprises at least one microwave transmitter and a microwave detector located in substantially diametrically opposed relationship on the upper part of the waste disposal chamber. The transmitter transmits microwaves of a desired frequency, and the receiver receives the microwaves. When waste is comprised in the upper part of the chamber, intersecting the path of the microwaves, some of the microwaves are absorbed by the waste, and thus the intensity of the received signal by the receivers diminishes accordingly. As the density and amount of waste in this part of the chamber increases, so does the absorption of the microwave energy increase, and the intensity of the received signal diminish. By calibrating the density of received signal, it is possible to determine whether or not there is waste at the height in the chamber where the transmitter and receiver are located.

The transmitter and the receiver are constructed as replaceable units, each of which comprises an outer metal casing, an inner ceramic or heat resistant material surrounding an innermost metal wave conductor. The conductor has an antenna with a screen. The units are adapted for mounting through the outer wall of the reactor via a suitable aperture, such that the screen can be brought into abutting contact with a another screen that is provided in the inner tube of the reactor, the inner tube representing the waste inlet system of the reactor that extends into the reactor from the top thereof It is important to maintain a “plug” of waste within the inner tube, and thus the transmitter and receivers monitor the height of the column within the tube. The transmitter and receiver units can be removed for servicing, for example, and the appropriate aperture closed with another unit or a plug, enabling virtually continuous operation of the reactor with minimal down time.

### DESCRIPTION OF FIGURES

FIG. 1 shows schematically the general layout and main elements of a typical waste plasma processing apparatus comprising a level monitoring system according to the first embodiment of the present invention;

FIG. 2 shows schematically a section of the apparatus of FIG. 1 along X-X;

FIG. 3 shows schematically the general relationship between the main elements of a first embodiment of the transceiver unit of the present invention;

FIG. 4 shows schematically a general relationship between two sets of transceiver units of FIG. 3 at different heights with respect to the conduit of the processing apparatus;

FIG. 5 shows schematically the general relationship between the main elements of another embodiment of the transceiver unit of the present invention; and

FIG. 6 shows schematically, in fragmented view, the general layout and main elements of another plasma waste processing apparatus comprising a level monitoring system according to the second embodiment of the present invention.

### DISCLOSURE OF INVENTION

The present invention is defined by the claims, the contents of which are to be read as included within the disclosure of the specification, and will now be described by way of example with reference to the accompanying figures.

The term microwave radiation refers to electromagnetic radiation in the UHF (Ultrahigh Frequency) range, i.e., about 300 MHz to about 3000 MHz. The term “waste converting apparatus” herein includes any apparatus adapted for treating, processing or disposing of any waste materials, including municipal waste (MSW), household waste, industrial waste, medical waste, sewage sludge waste (SSW), radioactive waste and other types of waste, in particular by means of plasma treatment.

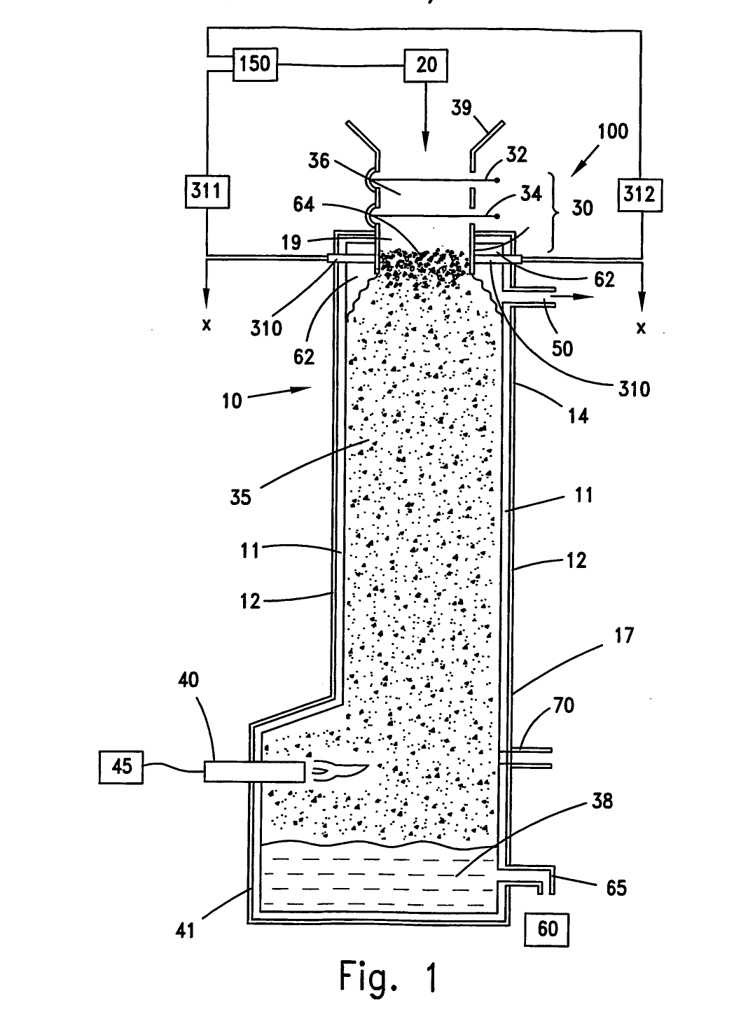

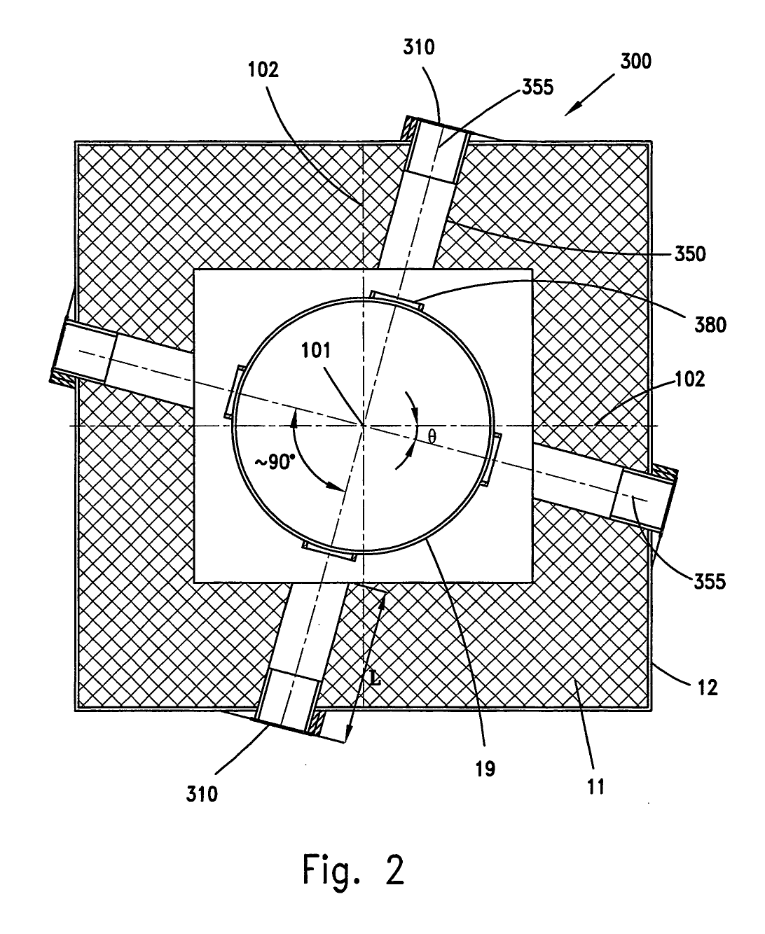

Referring to FIG. 1, a typical plasma waste processing/converting apparatus or plant, designated by the numeral (100), comprises a vertical furnace or processing chamber (10). The processing chamber (10) is typically in the form of a vertical shaft, the upper portion (14) of which may be of constant cross-section or alternatively of increasing or decreasing cross-section along the height thereof. For example, the chamber (10), and particularly the upper portion may be in the form of a cylindrical or frusta-conical or indeed any other desired shape, and the cross-section being substantially circular. Alternatively, the cross-section of the chamber (10) and particularly the upper part (14) is polygonal, preferably rectangular, as illustrated in FIG. 2. Typically, a solid or mixed waste feeding system (20) introduces typically solid waste at the upper end of the chamber (10) via a waste inlet means comprising an air lock arrangement (30). Mixed waste may also be fed into the chamber (10), though generally gaseous and liquid waste is removed from the apparatus (10) without substantial treatment. The solid/mixed waste feeding system (20) may comprise any suitable conveyor means or the like, and may further comprise a shredder for breaking up the waste into smaller pieces. The air lock arrangement (30) may comprise an upper valve (32) and a lower valve (34) defining a loading chamber (36) therebetween. The valves (32), (34) are preferably gate valves operated electrically, pneumatically or hydraulically to open and close independently as required. A closeable hopper arrangement (39) funnels typically solid and/or mixed waste from the feeding system (20) into the loading chamber (36) when the upper valve (32) is open, and the lower valve (34) is in the closed position. Feeding of waste into the loading chamber (36) typically continues until the level of waste in the loading chamber (36) reaches a predetermined point below full capacity, to minimize the possibility of any waste interfering with closure of the upper valve (32). The upper valve (32) is then closed. In the closed position, each of the valves (32), (34) provides an air seal. When required, the lower valve (34) is then opened enabling the waste to be fed into the processing chamber (10) with relatively little or no air being drawn therewith. The opening and closing of the valves (32), (34), and the feeding of waste from the feeder (20) may be controlled by any suitable controller (150), which may comprise a human controller and/or a suitable computer control system, operatively connected thereto and to other components of the plant (100).

Optionally, the hopper arrangement (39) may comprise a disinfectant spraying system (not shown in FIG. 1) for periodically or continuously spraying the same with disinfectant, as required, particularly when medical waste is being processed by plant (100).

The processing chamber (10) comprises a lower part (17), herein defined as comprising the hot zone of the chamber, wherein pyrolysis and gasification takes place. The lower part (17) comprises a liquid product collection zone (41), typically in the form of a crucible, having at least one outlet (65) associated with one or more collection reservoirs (60). The processing chamber (10) further comprises at the upper end thereof at least one gas outlet (50), primarily for channeling product gases, generated from the processing of waste, away from the processing chamber (10). The upper end of the processing chamber (10) comprises the air lock arrangement (30) and the processing chamber (10) is typically filled with waste material via the airlock arrangement (30) up to about the level of the primary gas outlet (50).

One or a plurality of plasma torches (40) at the lower part (17) of the processing chamber (10) are operatively connected to suitable electric power, gas and water coolant sources (45), and the plasma torches (40) may be of the transfer or non-transfer types. The torches (40) are mounted in the chamber (10) by means of suitably sealed sleeves, which facilitates replacing or servicing of the torches (40). The torches (40) generate hot gases that are directed downwardly typically at an angle into the bottom end of the column of waste. The torches (40) are distributed at the bottom end of the chamber (10) such that in operation, the plumes from the torches (40) heat the bottom of the column of waste, as homogeneously as possible, to a high temperature, typically in the order of about 1600° C. or more. The torches (40) generate at their downstream output ends hot gas jets, or plasma plumes, having an average temperature of about 2000° C. to about 7000° C. The heat emanating from the torches (40) ascends through the column of waste, and thus a temperature gradient is set up in the processing chamber (10). Hot gases generated by the plasma torches (40) support the temperature level in the chamber (10). This temperature level is sufficient at least at the lower part of the chamber (10) for continuously converting the waste into product gases that are channeled off via outlet (50), and into a liquid material (38) that may include molten metal and/or slag, which may be periodically or continuously collected at the lower end of the chamber (10) via one or more slag outlets (65) and into one or more reservoirs (60). Typically, the molten metal and the slag are collected separately in dedicated reservoirs. Hereinafter, unless otherwise specified, the reference numeral (60) indicates the slag reservoir.

Oxidizing fluid may be provided from a suitable source to convert char, produced during pyrolysis of organic waste, into useful gases such as CO and H₂, for example. The oxidizing fluid is introduced to the lower part of the chamber (10) via one or more suitable inlet ports (70). “Oxidizing fluid” is herein taken to include any gas or other fluid capable of oxidizing at least in part char found or produced in the hotter, lower parts of the processing chamber of the waste processing apparatus, and includes oxygen, steam, air, CO₂ and any suitable mixture thereof.

The inner facing surfaces (11) of processing chamber (10), at least of the lower part thereof, are typically made from one or more suitable refractory materials, such as, for example, alumina, alumina-silica, magnesite, chrome-magnesite, chamotte, or firebrick. Typically, the processing chamber (10), and generally the plant (100) as a whole, is covered by a metal layer (12) or casing to improve mechanical integrity thereof and to enable the processing chamber to be hermetically sealed with respect to the external environment.

The plant (100) preferably further comprises post processing means (not shown) operatively connected to the gas outlet (50) via a gas line, wherein the gas products generated in the chamber (10) are processed and cleaned. The post processing means may include any apparatus or system operatively connected to the waste processing chamber of the apparatus, in particular the gas outlet thereof, and adapted for the further processing of product gases generated by the waste processing chamber.

In particular, the processing chamber (10) further comprises a feeding conduit (19) extending into the chamber from the waste inlet means (30). The feed conduit (19) is adapted for accommodating and maintaining a “plug” of waste in the lower part of this conduit. The column of waste (35) extends from inside of this conduit (19) to the lower part (17) of the chamber (10) where gasification and pyrolysis of the waste is in progress. The conduit (19) is typically in the form of a vertical shaft, of constant cross-section or alternatively of increasing or decreasing cross-section along the height thereof. For example, the conduit (19) may be in the form of a cylindrical or frusta-conical or indeed any other desired shape, and the cross-section being substantially circular. Alternatively, the cross-section of the conduit (19) may be polygonal. The conduit (19) has an external lateral dimension—typically a diameter—that is substantially smaller than the inner width of the upper part (14) of the chamber in the vicinity of the conduit (19). Thus, the waste column (35) flares outwardly from the bottom edge of the conduit towards the inner walls (11) of the processing chamber. This provides a substantially peripheral space (62) between the upper part (14) of the chamber and the conduit outer wall (63), and the product gas outlet (50) is located in the chamber (10) such as to be in communication with this space (62). The plug of waste (64) within the conduit (19) provides a barrier to the product gases formed in the gasification process, substantially minimizing any outflow of the gases via the waste inlet system (30), thereby minimizing any potential fire or explosion hazard that may occur if the gases are released into the atmosphere, via the airlock system (30). Instead, the product gases are channeled out of the chamber substantially exclusively via the outlet port (50).

According to the present invention, a waste monitoring system (200) is provided and typically operatively connected to the controller (150) or to a different data acquisition, display and/or control means. The monitoring system (200) typically comprises one or more suitable detection apparatus (300), each detection apparatus (300) comprises one pair of microwave transceiver units (310), as described in more detail hereinbelow.

Each microwave transceiver unit is typically for use in a shaft furnace having an external wall and an inner wall spaced therefrom. Each microwave transceiver unit comprises first screen means transparent to microwave radiation, mountable to a suitable portal provided in the inner wall and a body. The body has a configuration adapted for reversibly mounting to the external wall through an aperture provided in that wall. The body has an axial dimension such that a first end of said body extends into the furnace from the aperture at least into proximity with the first screen, such as to permit relative movement between the body and the first screen means. The body comprising microwave transmission/receiving means associated with said first end and operatively connectable to any one of a microwave generating means and microwave detection means. During operation of said microwave transceiver unit at least a portion of said screen is in aligned relationship with said microwave transmission/receiving means and wherein said screen is sufficiently large to maintain an aligned relationship between at least a portion of said first screen with respect to said microwave transmission/receiving means for a range of displacements of said first screen with respect to said—microwave transmission/receiving means.

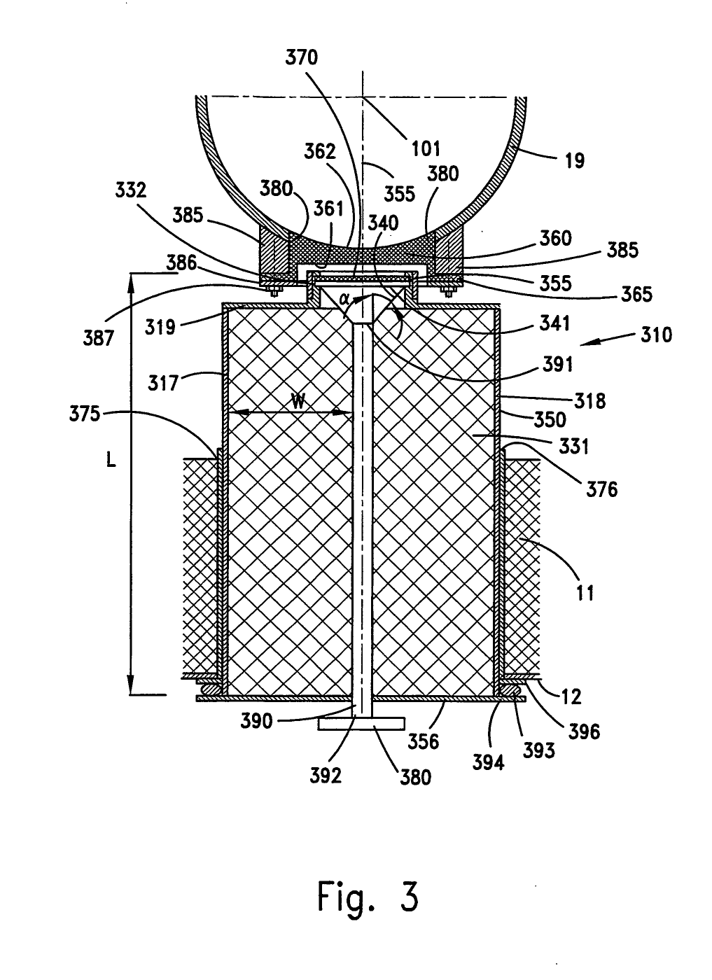

Thus, referring in particular to FIG. 2 and FIG. 3, according to a first embodiment of the present invention, each detection apparatus (300) comprises one pair of microwave transmitter/receiver or transmitter/detector units, herein referred to as transceiver units (310), which are mounted onto the wall (11,12) of the chamber (10), in opposed facing relationship and at substantially the same horizontal level. The axes (355) of the transceiver units (310) in a given detection apparatus (300) are coaxial, and preferably intersect the longitudinal axis (101) (or centerline) of the conduit (19).

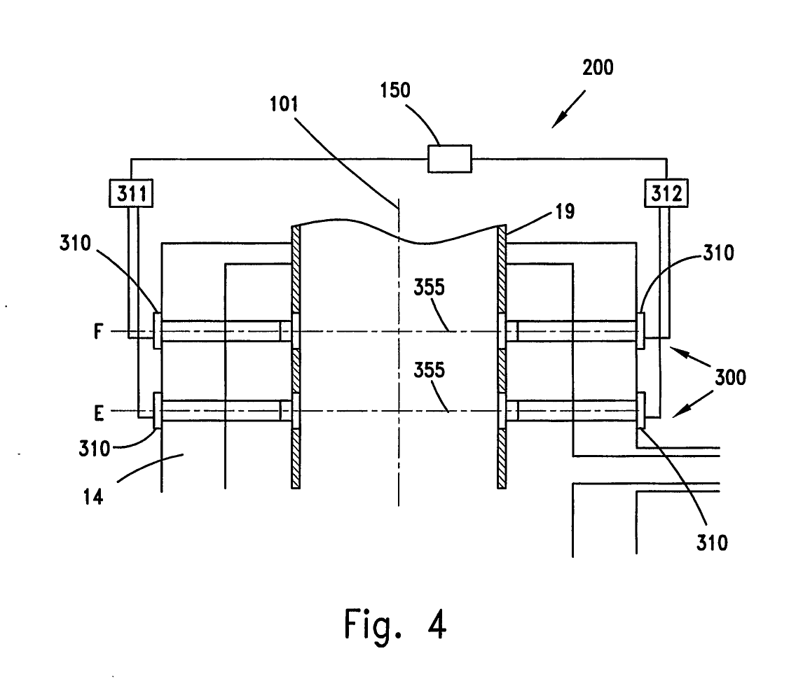

As best illustrated in FIG. 4, at least one apparatus (300) is preferably mounted at an upper part or level (F) of the conduit (19) for detecting when the level of waste reaches this level. Similarly, the monitoring system (200) typically also comprises at least one apparatus (300) at a level (E), vertically displaced downwards with respect to level (F) of the conduit (19), for detecting when the level of waste reaches this level. Preferably, and referring to FIG. 2, the axis of apparatus (300) at level (F) is angularly displaced with respect to the axis of the apparatus at level (E), when viewed along the longitudinal axis (101), the angular displacement preferably being about 90°. Additionally or alternatively, more than one pair of transceiver units (310) may be provided at any horizontal level, each pair being suitably displaced -angularly with respect to other pairs of transceiver unit (310). Additionally or alternatively, pairs of transceiver units (310) may be provided at more than two levels along the axis (101) of the conduit (19).

Level (F) may advantageously represent the maximum safety limit for waste in the chamber (10) and particularly in the conduit (19), while level (E) may, for example, represent a level of waste within the conduit (19) below which the “plug” of waste within the conduit (19) may be too thin to prevent escape of product gases therethrough and into the air lock arrangement (30). Alternatively, level (E) could also represent the level at which it is efficient to provide more waste to the chamber (10), and thus, the volume in the conduit (19) between level (E) and level (F) may be approximately equal to the volume of waste that may be accommodated in loading chamber (36).

Alternatively, or additionally, the locations of the apparatuses (300) at levels (F) and (E) may be chosen to provide suitable datums for determining an actual flow rate of the waste through the chamber (10) by measuring the time interval between the time when the level of waste is at level (F) to when it reaches level (E), for example. The controller (150) may also be operatively connected to valves (32), (34) to coordinate loading of the loading chamber (36) from the feeding system (20), and unloading of the waste from the loading chamber (36) to the processing chamber (10).

Thus, with the aid of the monitoring system (200) it is possible to detect when the level of waste drops sufficiently (as a result of processing in the chamber (10)) and thus the controller (150) may provide the necessary commands to enable another batch of waste to be fed to the processing chamber (10) via the loading chamber (36), preferably such that a plug of waste always remains within the conduit (19). The controller (150) then closes lower valve (34) and opens upper valve (32) to enable the loading chamber (36) to be re-loaded via feeding system (20), and then closes upper valve (32), ready for the next cycle.

According to the present invention, the two transceiver units (310) in each apparatus (300) are substantially identical, one transceiver unit (310) being used for transmitting microwave radiation, and is thus operatively connected to a suitable microwave generation means (311), and the other transceiver unit (310) being used to detect the transmitted microwave radiation, and are thus operatively connected to a detection unit (312), which converts microwave energy received by the corresponding transceiver unit (310) to suitable electrical signals. Alternatively, the transmitting and receiving transceiver units may be different one from the other. The microwave generating means (311) and the detection unit (312), which form part of the system (200), are operatively connected to the controller (150), or indeed to any suitable data acquisition, display and control means. The controller (150) receives signals obtained by the detection unit (312) and similarly controls the intensity of the microwave radiation transmitted by the corresponding transceiver units (310), and further comprises suitable programming to determine whether there exists waste at the level in which the transceiver units (310) of the apparatus is located, according to the relative intensities between the transmitted and received microwave radiations.

Referring in particular to FIG. 3, in the preferred embodiment each transceiver unit (310) comprises an elongate body (350) adapted for reversibly mounting to the wall (11, 12) of the chamber (10) via suitable apertures (375). The body (350) has an axial dimension (L) along axis (355) such that a first end (355) of the body (350) extends into the chamber (10) at least into proximity with the conduit (19), or alternatively in abutting contact with the conduit, as will be described further hereinbelow. Typically, the body (350) is substantially cylindrical.

Preferably, the apertures (375) each comprise a suitable sleeve member (376) having an external configuration, typically an external surface (377) of suitable shape and dimensions, that is adapted for sealingly mounting the sleeve member (376) into the aperture (375). Furthermore, the sleeve member (376) also comprises an internal configuration that is adapted for reversibly accommodating the body (350) sealingly with respect to the sleeve member (376). Thus, typically, the sleeve member (376) has a cylindrical internal wall that is complimentary to the outer surface of the body (350), and enables the body (350) to be inserted therethrough and to the required position opposite the conduit, as illustrated in FIG. 3, for example. Furthermore, the sleeve member (376) comprises an annular flange (396) which abuts against the external wall (12). The body (350) also comprises a flange (394) on the second end (356) thereof, which is of sufficient size and of appropriate shape such that when the body (350) is fully inserted in the sleeve member (376) the flanges (394) and (396) are superposed over a peripheral area circumscribing the outer metallic layer (318) of the body (350). A gasket (393) is provided between the flanges (394), (396) in this peripheral area such as to provide a seal between the body (350) and the sleeve member (376).

The body (350) comprises suitable microwave transmission/receiving means associated with said first end (355) and operatively connectable to either the microwave generating means (311) or to the microwave detecting unit (312). Thus, in the preferred embodiment, a metallic wave conductor (390) substantially aligned with the axis (355) is provided, typically in the form of a metal tube, made from a suitable metal, preferably stainless steel, copper or brass or alloys thereof, for example. At the transmitting/receiving end (391) of the conductor (390) an antenna (340) is comprised, integrally or otherwise connected thereto in an electrically conductive manner. Thus, the antenna (340) is also metallic, and preferably of the same material as the wave conductor (390), is typically frusto-conical in form and with its axis of revolution aligned with axis (355) and having its larger end pointing away from the wave conductor (390). In such an arrangement, the half angle α of the cone may be advantageously between about 20° and 30°, for example. The second end (392) of the conductor is adapted for connection to the microwave generating means (311) or the detection unit (312).

The wave conductor (390) is surrounded by a suitable insulation layer (331), preferably made from a suitable low density heat-insulating material, preferably a ceramic material, including porous ceramic. Preferably, the insulation is tubular having a width (W) of about 15 to 20 cm, for example, in a radial direction, and extends to cover the entire conductor (390) within the body (350), plus at least a portion of the antenna (340).

The body (350) further comprises an outer metallic layer (318), having a cylindrical portion (317) covering the outer cylindrical surface of the insulation layer (331), and an end portion (319) facing the conduit (19) and having a window (332) opposite the transmitting/receiving face (341) of antenna (340). A screen (370) covers the window (332), and is made from a suitable material that, while being substantially transparent to UHF electromagnetic radiation, also provides adequate thermal insulation for the antenna (340).

The apparatus (300) further comprises another set of screen means (360), which are mounted to suitable portals (380) provided in the conduit (19). The portals (380) are arranged in the conduit (19) such that the axes (355) of the transceiver unit (310), and in particular the microwave transmission/receiving means, are aligned with at least a portion of screen means (360) when these are mounted in the corresponding portals. The portals (380), and the screen means (360), are sufficiently large, at least in the longitudinal direction along the axis (101), such that this alignment is maintained even as the conduit expands and contracts thermally under the influence of temperature changes within the chamber (10). At the same time, and as stated hereinbefore, the body extends into said furnace at least into proximity with said screen means (360), such as to permit relative movement between said body (350) and said screen means (360). In the embodiment illustrated in FIG. 3, said body (350) is distanced from said screen means (360) by a displacement (d) sufficiently to permit displacement of said screen means (360) with respect to said microwave transmission/receiving means. Such a displacement (d) may be approximately 1 cm, for example, to allow also for possible radial outward expansion of the conduit (19).

While the conduit (19) may be cylindrical or indeed any other suitable shape, as discussed above, the screen means (360) preferably comprise an external surface (361), facing the transceiver unit (310), that is substantially planar. The inner facing surface (362) of the screen (360) follows the shape of the conduit (19), as illustrated in FIG. 3. In practice, the portals (380) are each surrounded by a suitable frame (385) that extends in the direction of the transceiver unit (310), and the screen (360) comprises flanges (365) which mate with said frame (385), secured thereto via bracket (386) and bolts (387). Advantageously, surface (361) is displaced from the flanges (365), providing a slot-like arrangement. Correspondingly, the end (319) of the body (350) comprises a projection part containing at least part of the antenna (340) and the screen means (370), and having external dimensions such as to fit within the slot-like arrangement.

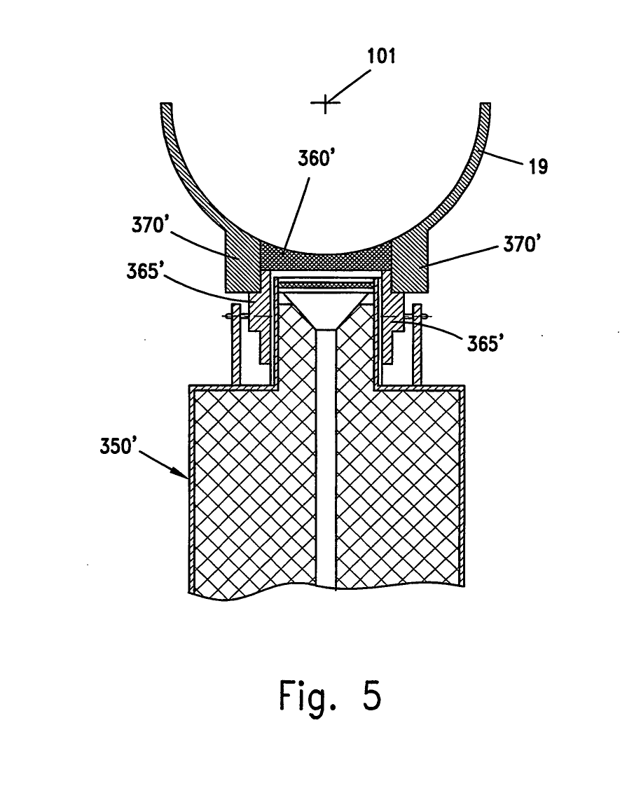

Referring to FIG. 5, in an alternative embodiment, the body, herein designated with the reference numeral (350′), comprises displacement means in abutting contact with either the inner wall of conduit (19) or the screen means (360′) to permit displacement of said screen means (360′) with respect to said microwave transmission/receiving means. In particular, the displacement means comprises at least one, and preferably a plurality of rollers or wheels (365′) mounted for rotation with respect to said body (350). The wheels are each in rotatable contact with either the conduit (19) or the screen means (360). Preferably, suitable rails (370′) are provided on the conduit (19) and/or screen means (360′) corresponding to the wheels (365′), and during operation of said transceiver unit, the wheels (365′) are in rotatable contact with corresponding rails, enabling the body (350′) to remain substantially stationary while the conduit (19) is sliding displaced with respect thereto in a direction substantially along the axis (101). The clearance between the wheels and the rails (or the screen or conduit) is sufficient to prevent interference between these components in directions other than along the axis (101).

Referring to FIG. 2, where the upper part (14) of the chamber (10) is typically, but not necessarily, of substantially rectangular or square section, the transceiver unit (310) may be disposed with respect to the upper part (14) such that the axes (355) are each at an angle θ with respect to the planes of symmetry (102). The angle θ may range from about 0° to about 90°. In the embodiment illustrated in FIG. 3, −angle θ is about 10°, but this may vary according to the specific needs and design of the specific furnace.

The apparatus (300) is thus retrofittable with respect to existing waste processing plants which comprise a conduit (19) by first providing suitable apertures such as apertures (375) in the outer chamber walls, and providing portals such as portals (380) in the conduit. Thereafter, screen means (360) are mounted onto the portals, and said body (350) is inserted via the apertures into alignment with the screen means (360).

In operation, for each pair of transceiver units (310), one transceiver unit (310) transmits microwave energy via the screen means (360) into the space enclosed by the conduit (19). In the absence of waste in the conduit at the horizontal level of the said transceiver units (310), the receiving transceiver unit (310) will receive substantially the full microwave energy transmitted by the transmitting transceiver unit (310), and this is sensed by the controller (150) via the signals provided by the detection unit (312). When there is waste within the conduit at the level of the transceiver unit (310), the intensity of the microwave radiation received by the receiving transceiver unit (310) is reduced, and this reduction is correlated to the volume, composition and density of waste traversed by the microwave radiation within the conduit (19).

Typically, the controller (150) is programmed to recognize a threshold value of the decrease in intensity of the microwave radiation that corresponds to a particular volume, mass and/or density of waste at the level where the transceiver units (310) are located, this volume, mass and/or density of waste being sufficient to indicate that the general level of the waste has reached, or is higher than, the level of the transceiver units (310). However, since each of the parameters volume, mass and density of the waste may have an effect on the reduction of intensity of the received radiation, the controller (150) preferably needs to be programmed such as to distinguish between genuine cases where the waste fully fills the conduit (19) at the level of the transceiver units (310), and cases where the same reduction in received intensity may be obtained while the conduit (19) is not fully filled. For example, a large volume of substantially homogeneous low density/low mass waste may fully fill the conduit (19) at the level of the transceiver units (310) while only reducing the received radiation intensity by a moderate amount. On the other hand a relatively smaller volume of high density, non-homogeneous waste may comprise, for example, a metal girder or other dense material that may project upwards from the average level of the waste and into the path of the microwave radiation sent from one transceiver unit (310) to the other transceiver unit (310) of a pair. The presence of such a girder may reduce the intensity of the radiation received by the receiving transceiver unit (310), perhaps to the same level as in the previous case of low density case, even though the general level of the waste does not reach the level of the transceiver units (310). A situation could develop in the latter case where a path is allowed to form for the product gases into the conduit (19), which should be avoided.

If the threshold value of the reduction of received microwave radiation is changed sufficiently so as to ensure compensation for the high density case, such that the threshold value is reached when high density waste fully fills the level of the conduit (19) at the transceiver units (310), then it may occur that when the conduit (19) is fully filled with low density waste, the controller (150) may be correspondingly desensitized to the presence of this waste. This is an unsatisfactory situation, since the controller (150) may continue to provide waste to an already filled conduit (19), and perhaps clog the air lock system, preventing proper operation thereof.

However, and in practice, the type and density of waste provided to the plant (100) is typically kept within a known range, and thus the controller (150) can be correspondingly programmed to take into consideration the expected density of the waste. Alternatively, the controller (150) may be operatively connected to a suitable means for determining the average density of each batch of waste being sent to the plant (100), and to adapt the threshold value accordingly as each batch is introduced to the processing chamber.

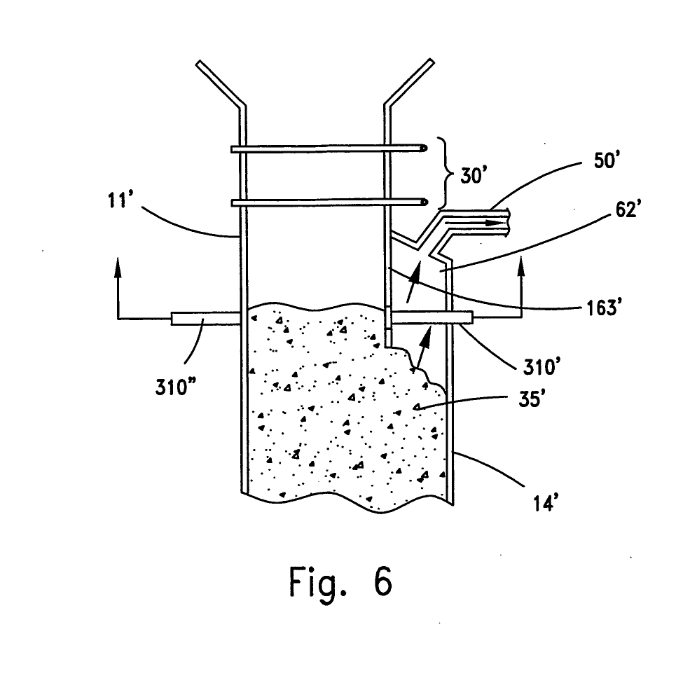

The present invention is also directed to other types of plasma waste converting/processing plants in which, rather than having a conduit projecting into the processing chamber as described with reference to FIG. 1, the plant comprises a different arrangement for minimizing the risk of product gases escaping via the air lock system. Thus, referring to FIG. 6, in a second embodiment of the apparatus and system of the present invention, the upper part (14′) of the plant comprises an inner wall (63′) that projects thereinto from only part of the airlock arrangement (30′), such that the plug of waste (35′)is bounded by part of the outer wall (11′) and the inner wall (63′) before fanning out to the full breadth of the chamber (10′). A space (62′) is thus formed between part of the outer wall (11′) and the inner wall (63′) in which product gases can escape via outlet (50′). In such a case, it is only necessary to provide one said transceiver unit (310 at the outer wall (11′) such that the transceiver unit (310) extends into proximity with a suitable screen means provided in a suitable aperture formed on the inner wall (63′), similar to that described above with reference to the feed conduit, mutatis mutandis. At the same time a regular transceiver (310″) may be provided on the outer wall (11′) substantially diametrically opposite to the location of the first transceiver (310). Determination of the level of waste may then be determined as described above with respect to the first embodiment, mutatis mutandis.

While the present invention is particularly adapted for detecting the level of waste in a shaft furnace or the like, it is also useful in other high temperature applications such as for example in metallurgical facilities.

While the foregoing description describes in detail only a few specific embodiments of the invention, it will be understood by those skilled in the art that the invention is not limited thereto and that other variations in form and details may be possible without departing from the scope and spirit of the invention herein disclosed.

1. A microwave transceiver unit for use in a shaft furnace having an external wall and an inner wall spaced therefrom, said microwave transceiver unit comprising:
first screen means transparent to microwave radiation, mountable to a suitable portal provided in said inner wall;
an elongate body having a configuration adapted for reversibly mounting to said external wall through an aperture provided in said external wall, said body having an axial dimension such that a first end of said body extends into said furnace from said aperture at least into proximity with said first screen, such as to permit relative movement between said body and said first screen means;
said body comprising microwave transmission/receiving means associated with said first end and operatively connectable to any one of a microwave generating means and microwave detection means;
wherein during operation of said microwave transceiver unit at least a portion of said screen is in aligned relationship with said microwave transmission/receiving means and wherein said screen is sufficiently large to maintain an aligned relationship between at least a portion of said first screen with respect to said microwave transmission/receiving means for a range of displacements of said first screen with respect to said microwave transmission/receiving means.

2. A microwave transceiver unit as claimed in claim 1, wherein the body comprises:
a metallic wave conductor coupled at a first end thereof to the transmission/receiving means, the second end of the conductor being operatively connectable to any one of a microwave generation means and a microwave detection means;
an insulation layer substantially surrounding at least said conductor; an outer metallic layer substantially surrounding said insulation layer.

3. A microwave transceiver unit as claimed in claim 2, wherein the microwave transmission/receiving means comprises an antenna operatively connected to the wave conductor.

4. A microwave transceiver unit as claimed in claim 3, wherein the antenna is substantially frusto-conical having the larger end thereof as a transmitting/receiving face.

5. A microwave transceiver unit as claimed in claim 3, wherein the wave conductor and the antenna are integrally joined.

6. microwave transceiver unit as claimed in claim 3, wherein the wave conductor and the antenna are made from any suitable metal including any one of stainless steel, copper and brass or alloys thereof.

7. A microwave transceiver unit as claimed in claim 4, further comprising a second screen means covering the transmission/receiving face of the antenna, said second screen means being substantially transparent to microwave electromagnetic radiation.

8. A microwave transceiver unit as claimed in claim 7, wherein the first screen means and the second screen means are made from any suitable dielectric material.

9. A microwave transceiver unit as claimed in claim 2, wherein the insulation layer is substantially tubular.

10. A microwave transceiver unit as claimed in claim 2 to 9, wherein the outer metallic layer is made from steel.

11. A microwave transceiver unit as claimed in claim 1 wherein the body has a substantially cylindrical external profile.

12. A microwave transceiver unit as claimed in claim 11, further comprising a sleeve member having:
an external configuration adapted for sealingly mounting said sleeve in the aperture in the wall of the furnace; and
an internal configuration adapted for reversibly accommodating the body sealingly with respect thereto.

13. microwave transceiver unit as claimed in claim 12, wherein the sleeve member and the body each comprise suitable flanges which are mutually facing when said sleeve member and said body are mounted together.

14. A microwave transceiver unit as claimed in claim 13, further comprising a suitable sealing gasket adapted for accommodation between the mutually facing flanges for sealing the sleeve member with respect to the body.

15. A microwave transceiver unit as claimed in claim 1, wherein the range of displacements is correlated to the thermal expansion of the inner wall with respect to the outer wall.

16. A microwave transceiver unit as claimed in claim 1, wherein the body is distanced from the first screen means sufficiently to permit displacement of said first screen means with respect to the microwave transmission/receiving means.

17. A microwave transceiver unit as claimed in claim 1, wherein the body comprises displacement means in abutting contact with one of the inner wall and the first screen means to permit displacement of said first screen means with respect to the microwave transmission/receiving means.

18. A microwave transceiver unit as claimed in claim 17, wherein the displacement means comprises at least one wheel mounted for rotation with respect to the body, wherein said wheel is in rotatable contact with at least one of the inner wall and the first screen means.

19. A microwave transceiver unit as claimed in claim 18, further comprising at least one suitable rail on at least one of the inner wall and the first screen means corresponding to the at least one wheel, wherein during operation of said transceiver unit, said at least one wheel is in rotatable contact with a corresponding said rail.

20. Apparatus for monitoring waste in a waste converting apparatus, said waste converting apparatus comprising a waste processing chamber having a waste inlet port at an upper longitudinal end thereof and an external peripheral wall, and further comprising an internal wall extending from said inlet into said chamber to a predetermined depth such as to a form waste conduit and a space between an outside of said internal wall and an inside of at least a part of said external wall, said apparatus comprising at least one pair of microwave transceiver units, comprising at least one said microwave transceiver unit as claimed in claim 1, wherein for each said pair:
said microwave transceiver units are arranged in opposed horizontal relationship with respect to said upper longitudinal end;
the body of each said microwave transceiver unit is sealingly accommodated in an aperture formed in said outer peripheral wall;
the conduit comprises a pair of portals comprising a first screen means, said portals being located on said conduit at positions such that each said first screen means is aligned with a corresponding one of said microwave transceiver units of said pair; and
one said transceiver unit is operatively connectable to a suitable microwave generating means, the other said transceiver unit is operatively connectable to a suitable microwave detection means.

21. Apparatus for monitoring waste as claimed in claim 20, wherein the internal wall is a waste conduit in the form of an internal peripheral wall extending from the inlet into the chamber to a predetermined depth such as to form a peripheral space between an outside of the conduit and an inside of the external wall.

22. Apparatus for monitoring waste as claimed in claim 20, wherein at least one pair of microwave transceiver units comprises a regular microwave transceiver unit.

23. Apparatus for monitoring waste as claimed in claim 20, comprising more than one pair of microwave transceiver units, wherein each said pair is located at a different height along the depth of the conduit.

24. Apparatus for monitoring waste as claimed in claim 20, comprising more than one pair of microwave transceiver units, wherein each said pair is located at a different angular disposition with respect to a longitudinal axis of the conduit.

25. Apparatus for monitoring waste as claimed in claim 24, wherein adjacent pairs are arranged in orthogonal relationship with respect to a longitudinal axis of the conduit.

26. System for monitoring waste in a waste converting apparatus comprising at least one apparatus as claimed in claim 20, wherein for each pair of transceiver units, one said transceiver unit is operatively connected to a suitable microwave generation means, and wherein the other transceiver unit of said pair is operatively connected to a suitable microwave detection unit.

27. System as claimed in claim 26, further comprising suitable control means operatively connected to the microwave generation means and to the microwave detection unit.

28. A method for monitoring the level of waste in a shaft furnace having an external wall and an inner wall spaced therefrom, comprising:
(a) providing at least at one location on said shaft furnace:
an aperture in said outer wall;
an aperture in said inner wall and covering the same with suitable screen means; and
a first suitable microwave transmission/receiving means through said aperture into proximity with said screen means, such that a part of said transmission/receiver means is in sealing contact with said outer wall;
(b) providing a second microwave transmission/receiving means substantially diametrically opposed to said first transmission/receiving means;
(c) transmitting suitable microwave radiation via one of said first or second microwave transmission/receiving means and receiving a received radiation with the other one of said first or second microwave transmission/receiving means; and
(d) comparing the intensity of the received radiation with the transmitted radiation to determine the level of waste in said shaft furnace by relating said comparison of intensities to a threshold value.

29. The method of claim 28, wherein when the intensity of the received radiation is below a predetermined threshold value it is determined that the level of waste is substantially below the level of the first microwave transmission/receiving means.

30. The method of 28, wherein when the intensity of the received radiation is at or above a predetermined threshold value it is determined that the level of waste is substantially at or above the level of the first microwave transmission/receiving means.

31. The method of claim 28, wherein a second pair of microwave transmission/receiving means is provided at a location longitudinally displaced from the first and second microwave transmission/receiving means, and wherein a waste flow rate in the furnace is determined by determining the time interval between the point at which it is determined that one of said pairs of microwave transmission/receiving means is no longer detecting waste and the point at which the next pair of said microwave transmission/receiving means is no longer detecting waste thereat.

32. The method of claim 28, wherein the threshold value may be controlled as desired.

33. The method of claim 32, wherein the threshold value is adjusted according to the general composition of the waste being introduced into the furnace.

34. A microwave transceiver unit for use in a shaft furnace, substantially as herein described with reference to the accompanying figures.

35. Apparatus for monitoring waste in a waste converting apparatus, substantially as herein described with reference to the accompanying figures.

36. System for monitoring waste in a waste converting apparatus, substantially as herein described with reference to the accompanying figures.

37. Method for monitoring waste in a waste converting apparatus, substantially as herein described with reference to the accompanying figures.
